(19) United States
(12) Patent Application Publication
(10) Pub. No.: US 2020/0067394 A1
(43) Pub. Date: Feb. 27, 2020

(54) ACTUATOR AND ELECTRONIC DEVICE

(71) Applicant: NIDEC COPAL CORPORATION, Tokyo (JP)

(72) Inventors: Satoru ISHIKAWA, Tokyo (JP); Yoshihide TONOGAI, Tokyo (JP)

(73) Assignee: NIDEC COPAL CORPORATION, Tokyo (JP)

(21) Appl. No.: 16/551,261

(22) Filed: Aug. 26, 2019

(30) Foreign Application Priority Data
Aug. 27, 2018 (JP) 2018-157961

(51) Int. Cl. H02K 33/16; B06B 1/04; H02K 1/34

(52) U.S. Cl. CPC H02K 33/16; H02K 33/18; H02K 1/34; B06B 1/045

(57) ABSTRACT

An actuator, having a case portion that includes a permanent magnet; a movable portion that is able to move in respect to the case portion; and elastic members that are provided between the case portion and the movable portion, wherein: the movable portion includes a weight portion that has a flat portion that faces the case portion and an opening portion in the flat portion, and a coil that is provided on the inside of the opening portion, wherein: a groove for connecting the opening portion and the outer surface of the weight portion is provided in the flat portion.

### CROSS-REFERENCE TO RELATED APPLICATION

This application claims priority to Japanese Patent Application No. 2018-157961 filed Aug. 27, 2018. This application is incorporated herein by reference in its entirety.

### FIELD OF TECHNOLOGY

One aspect of the present invention relates to an actuator that is used in an electronic device, or the like.

### BACKGROUND

Many electronic devices, such as mobile terminals, and the like, have functions that cause the electronic device to vibrate, in order to inform the user of an incoming call that information has been received, or to communicate to the finger the sensation of having operated the touch panel. Such a function is achieved through the operation of an actuator, or the like, that is disposed within the electronic device. Such actuators are disclosed in, for example, Japanese Unexamined Patent Application Publication 2018-1108, Japanese Unexamined Patent Application Publication 2017-70018, and Japanese Unexamined Patent Application Publication 2011-72856.

### SUMMARY OF THE INVENTION

Actuators that have functions for causing electronic devices to vibrate typically comprise: a stationary portion; a movable portion that undergoes reciprocating motion along an axial direction in respect to the stationary portion; and a driving portion for driving the movable portion. In the actuators described in Patent Document 2018-1108 and 2017-70018, coils and permanent magnets are provided respectively in the stationary portions and movable portions, as the driving portions.

However, there are moving coil-type actuators, such as the actuator described in Patent Document 2011-72856, wherein the coil and the permanent magnet are disposed, respectively, on the movable portion and the stationary portion, as the driving portion. In the moving coil-type actuator, there is the need to secure the strength of the vibration through increasing the mass of the movable portion while supplying electric current to the coil that undergoes reciprocating motion. That is, in an actuator wherein the coil is provided on the movable portion, a technology is needed that enables the electric current to be supplied to the coil while increasing the mass of the movable portion.

The present invention adopts means such as the following in order to solve the problem described above. Note that while in the explanation below, reference symbols from the drawings are written in parentheses for ease in understanding the present invention, the individual structural elements of the present invention are not limited to those that are written, but rather should be interpreted broadly, in a range that could be understood technically by a person skilled in the art.

Example according to the present invention is an actuator having a case portion that includes permanent magnets, a movable portion that can move in respect to the case portion; and elastic members that are provided between the case portion and the movable portion. The movable portion includes a weight portion that has a flat portion that faces the case portion, and an opening portion in the flat portion; and a coil that is provided inside of the opening portion, wherein a groove for connecting the opening portion and the outer surface of the weight portion is provided in the flat portion.

The actuator of the configuration set forth above enables securing of a space for connecting the outside of the movable portion and the opening portion, between the case portion and the weight portion, while enabling a larger mass for the weight portion. This enables the electric current to be supplied through this space from the outside of the movable portion to the coil that is positioned inside of the opening portion. That is, this enables the electric current to be supplied to the coil while increasing the mass of the movable portion in an actuator wherein the coil is provided on the movable portion.

Preferably the actuator described above further comprises: lead wires for supplying electric power to the coil; and a connecting portion for the lead wires and the coil, wherein: the connecting portion is positioned in the groove.

The configuration set forth above enables the connecting portion to be approached from the side of the flat shape part, which is more open, enabling the operation for connecting the lead wires and the coil to be carried out more easily. This enables an improvement in manufacturability of the actuator.

In the actuator set forth above, preferably the direction of the groove crosses the direction of movement of the movable portion (the z axial direction).

The actuator configured as set forth above enables the lead wires supplying the electric current to the coil to be introduced from the side of the movable portion, leaving more space on the side of the movable portion in the direction of movement. This enables greater freedom in the design of the actuator.

In the actuator set forth above, preferably: the case portion includes two permanent magnets that face each other with the coil therebetween.

The actuator configured as set forth above enables an increase in the magnetic flux density of the coil, enabling an increase in the electromagnetic force that acts on the coil. This enables an increase in the driving force in respect to the movable portion, thus enabling an increase in the strength of the vibration of the actuator.

Preferably, the actuator set forth above further has a lead wire for supplying electric power to the coil; and a substrate that has flexibility, and on which at least a portion of the lead wire is provided.

The actuator configured as described above enables routing of the lead wires while preventing entanglement through the provision of the lead wires on a substrate that is, for example, an FPC (flexible printed circuit).

Any of the actuators set forth above may be applied suitably to an electronic device (100) such as a personal computer, a smart phone, a tablet, or the like.

The electronic device configured as set forth above enables, in the actuator, space for connecting the opening portion and the outside of the movable portion, between the case portion in the weight portion, while securing a larger mass for the weight portion. This enables the electric current to be supplied through this space from the outside of the movable portion to the coil that is positioned inside of the opening portion. That is, this enables the electric current to be supplied to the coil while increasing the mass of the movable portion in an actuator wherein the coil is provided on the movable portion. This enables a vibration of a greater vibrational strength to be applied to the electronic device, enabling an improvement in the feeling of having operated the electronic device.

### BRIEF DESCRIPTIONS OF THE DRAWINGS

FIG. 1 is a perspective diagram of a linear motor according to the present example.

FIG. 2 is a front view of the linear motor according to the present example.

FIG. 3 is a cross-sectional diagram at the position of the section of FIG. 2 of the linear motor in the present example.

FIG. 4 is a cross-sectional diagram at the position of the section IV-IV of FIG. 2 of the linear motor in the present example.

FIG. 5 is a cross-sectional diagram at the position of the section V-V of FIG. 2 of the linear motor in the present example.

FIG. 6 is a cross-sectional drawing of the linear motor according to the present example.

FIG. 7 is a perspective diagram of a linear motor according to the present example.

FIG. 8 is a perspective diagram of a mobile information terminal according to the present example.

### DETAILED DESCRIPTION

An actuator according to the present invention has, as its distinctive feature, the point that it is configured comprising: a case portion that includes a permanent magnet; a movable portion that is able to move in respect to the case portion; and elastic members that are provided between the case portion and the movable portion, wherein: the movable portion includes a weight portion that has a flat portion that faces the case portion and an opening portion in the flat portion, and a coil that is provided on the inside of the opening portion, wherein: a groove for connecting the opening portion and the outer surface of the weight portion is provided in the flat portion.

An embodiment according to the present invention will be explained, following the structures below. However, the embodiment explained below is no more than an example of the present invention, and must not be interpreted as limiting the technical scope of the present invention. Note that in the various drawings, identical reference symbols are assigned to identical structural elements, and explanations thereof may be omitted.

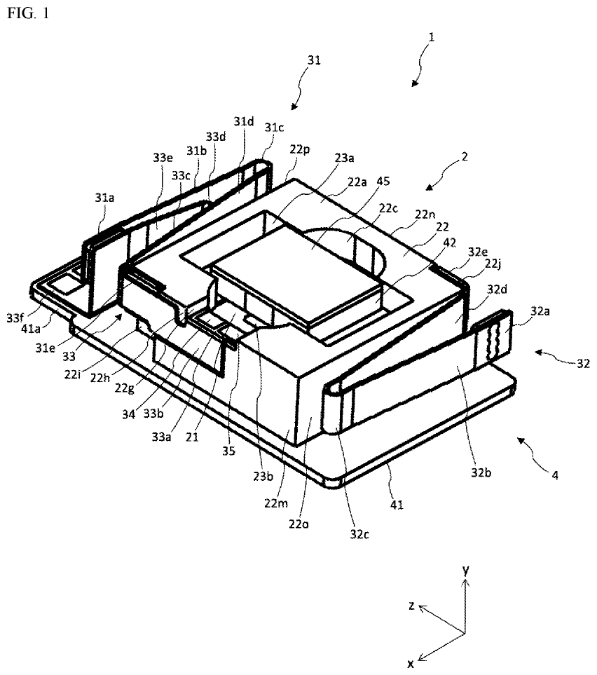

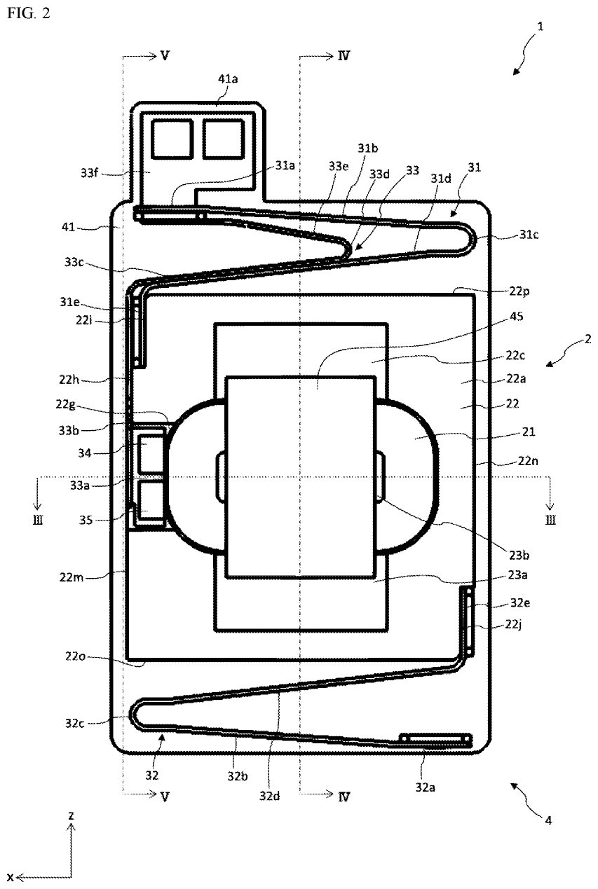

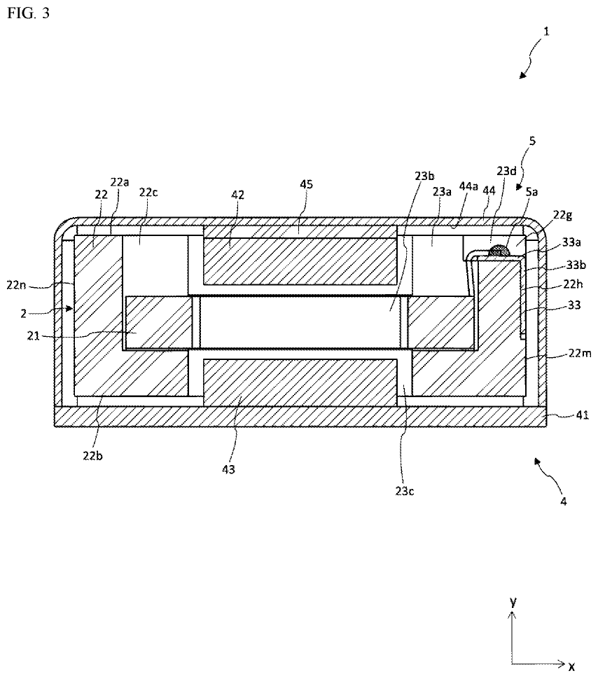

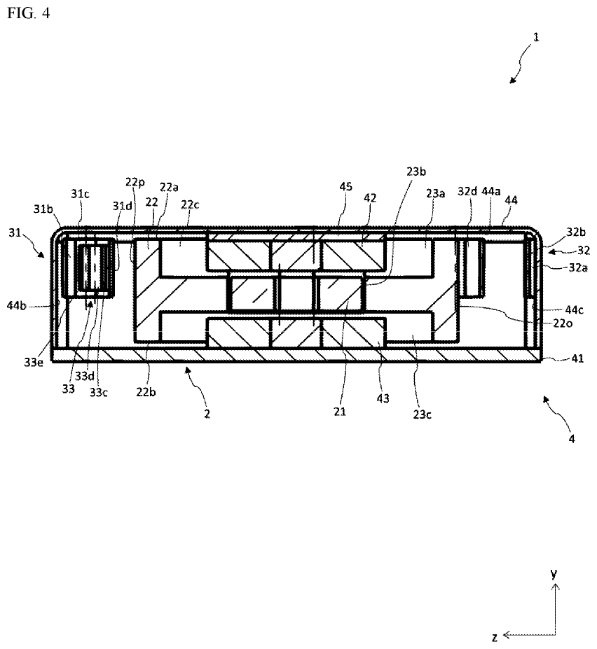

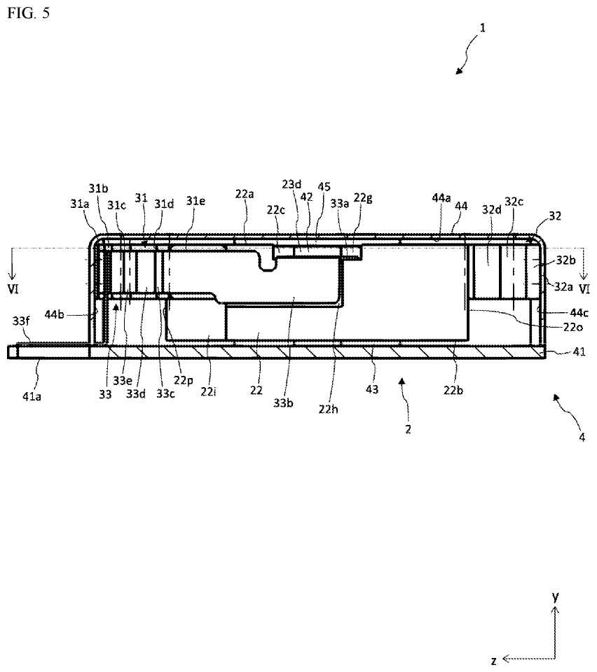

Examples according to the present invention will be explained in reference to the drawings. FIG. 1 is a perspective diagram of a linear motor according to the present embodiment. FIG. 2 is a front view of the linear motor according to the present embodiment. FIG. 3 is a cross-sectional diagram at the position of the section of FIG. 2 of the linear motor in the present embodiment. FIG. 4 is a cross-sectional diagram at the position of the section IV-IV of FIG. 2 of the linear motor in the present embodiment. FIG. 5 is a cross-sectional diagram at the position of the section V-V of FIG. 2 of the linear motor in the present embodiment. Note that the case 44 is not illustrated in FIG. 1 and FIG. 2. The connecting portion 5 is not illustrated in FIG. 1, FIG. 2, and FIG. 5.

The x axis, the y axis, and the z axis are shown in each drawing. The axis that is parallel to the direction of movement of the movable portion 2 (hereinafter termed the “movement direction”) that, when viewed from the direction from the leaf spring 32 that is not provided on the FPC 33, is toward the leaf spring 31 that is provided on the FPC 33, is defined as the “z axis.” The axis that is perpendicular to the z axis and that is in the direction of the groove 22g when viewed from the driving magnet 42 is defined as the “x axis.” Moreover, the axis that is perpendicular to both the z axis and the x axis, and that, when viewed from the driving magnet 43, is in the direction of the driving magnet 42, is defined as the “y axis.” Here the x axis, the y axis, and the z axis form right-handed three-dimensional Cartesian coordinates. In the below, the direction of the arrow for the z axis may be termed the “z-axial positive side” and the opposite direction may be termed the “z-axial negative side,” with the same for the other axes as well.

### <Linear Motor 1>

As depicted in FIG. 1 through FIG. 5, a linear motor 1 according to the present embodiment is structured including a movable portion 2, leaf springs 31 and 32, a case portion 4, a connecting portion 5, and an FPC 33. The linear motor 1 is attached to an electronic device such as, for example, a smart phone, a tablet, a laptop computer (notebook PC), a game controller, or the like. The linear motor 1 is one specific example of an “actuator” in the present invention.

### <Case Portion 4>

The case portion 4 is configured including a base plate 41, driving magnets 42 and 43, a case 44, and a back yoke 45. The case portion 4 functions as a stationary portion that is secured to the electronic device.

### <Base Plate 41>

The base plate 41 is a plate-shaped member that has an essentially rectangular cross-section, having a first face that faces toward the y-axial positive side and a second face that faces toward the y-axial negative side. In the present embodiment, the base plate 41 is formed from a ferromagnetic material such as iron, to prevent the magnetic flux from the driving magnet 43, and the like, from leaking to the outside of the case portion 4. A protruding portion 41a, for protruding in the z-axial positive side is provided on the end portion of the base plate 41 on the z-axial positive side.

### <Case 44>

The case 44 is a member that, together with the base plate 41, forms the case for the linear motor 1, and is formed from a resin, a metal, or the like (referencing FIG. 1 through FIG. 3). In the case 44, the y-axial negative side has a recessed shape that is open, to enable coupling with the base plate 41. The case 44 and the base plate 41 are connected to form a space for containing the movable portion 2, the leaf springs 31 and 32, the connecting portion 5, the FPC 33, the driving magnets 42 and 43, along with the back yoke 45, and the like. Here the inner surface of the case 44 that faces the direction of the base plate 41 that faces the y-axial positive side is defined as the bottom face 44a (referencing FIG. 3 through FIG. 5).

### <Back Yoke 45>

The back yoke 45 is a plate-shaped member that has essentially the same cross-section as the cross-section of the driving magnet 42, and has a first face that in the direction of the y-axial positive side and a second face in the direction of the y-axial negative side. In the present embodiment, the back yoke 45 is formed from a ferromagnetic material such as iron, to prevent magnetic flux, from the driving magnet 42, and the like, from leaking to the outside of the case portion 4. The back yoke 45 is secured to the case 44 through, for example, adhesive bonding of the first face to essentially the center of the bottom face 44a of the case 44.

### <Driving Magnets 42 and 43>

The driving magnets 42 and 43 face each other, with the coil 21 therebetween. In the present embodiment, the driving magnet 42 is a plate-shaped permanent magnet, and has a first face in the direction of the y-axial positive side, and a second face in the direction of the y-axial negative side. The driving magnet 42 is secured to the case portion 4. In the present embodiment, the driving magnet 42 is secured to the case 44 through adhesively bonding the first face to the second face of the back yoke 45 in a state wherein the side face of the driving magnet 42 is positioned aligned with the side face of the back yoke 45, for example.

The driving magnet 43 is a plate-shaped permanent magnet that has essentially the same shape as the driving magnet 42, and has a first face in the direction of the y-axial positive side and a second face in the direction of the y-axial negative side. The driving magnet 43 is secured to the case portion 4 so as to face the driving magnet 42 with the coil 21 therebetween. In the present embodiment, the driving magnet 42 is, for example, secured to the base plate 41 through adhesive bonding of the second face to essentially the center of the y-axial positive side face of base plate 41. Driving magnets 42 and 43 are one specific example of “permanent magnets” in the present invention.

### <Movable Portion 2>

The movable portion 2 is structured including the coil 21 and the weight 22. The movable portion 2 is able to move along the movement direction in respect to the case portion 4.

### <Weight 22>

The weight 22 is a ring-shaped member with an outer shape that is essentially rectangular, having a flat portion that faces the case portion 4. Specifically, the weight 22 is formed from a high density material, such as, for example, tungsten.

The weight 22 has a first face 22a in the direction of the y-axial positive side, facing the bottom face 44a of the case 44, and a second face 22b, in the direction of the y-axial negative side, facing the first face of the base plate 41. There is a gap of a prescribed interval between the bottom face 44a and the first face 22a. There is a gap of a prescribed interval between the first face of the base plate 41 and the second face 22b. The weight 22 is one specific example of a “weight portion” in the present invention. The first face 22a is one specific example of a “flat portion” in the present invention.

A through hole 22c that is parallel to the y axis is formed in essentially the center of the first face 22a of the weight 22. An escape space 23a, a storing space 23b, and an escape space 23c are formed continuously, from the y-axial positive side to the y-axial negative side, in the through hole 22c (referencing FIG. 3 and FIG. 4). The through hole 22c is one specific example of an “opening portion” in the present invention.

The escape space 23c is a space able to contain the driving magnet 43 that protrudes into the through hole 22c from the base plate 41 toward the y-axial positive side. Specifically, the escape space 23c has a cross-section that will not physically interfere with the weight 22 or the driving magnet 43 despite the weight 22 undergoing reciprocating motion. The storing space 23b has a space that is able to contain the coil 21. Specifically, the cross-section of the storing space 23b is slightly larger than the cross-section of the coil 21. The escape space 23a is a space able to contain the driving magnet 42 that protrudes into the through hole 22c from the bottom face 44a of the case 44 in the direction of the y-axial negative side. Specifically, the escape space 23a enables the coil 21 to pass therethrough, and has a cross-section that does not physically interfere with the weight 22 or the driving magnet 42 despite the weight 22 undergoing reciprocating motion.

A groove 22g for connecting the through hole 22c and the first face 22a of the weight 22 is provided on the first face 22a. The direction in which the groove 22g extends is perpendicular to the movement direction of the movable portion 2. Specifically, the groove 22g is formed through forming the x-axial positive side of the through hole 22c, to have a squared groove cross-section, extending in parallel to the x axis. The groove 22g connects the escape space 23a and the side face 22m of the weight 22 on the x-axial positive side. In a state went assembled together with the case 44 and the base plate 41, an introduction space 23d that connects between the outside of the weight 22 and the through hole 22c is formed between the bottom face 44a of the case 44 and the weight 22 (referencing FIG. 3 and FIG. 5).

At the side face 22m, at the end portion on the z-axial positive side, a stepped portion 22i is formed spanning from the first face 22a to the second face 22b. The step difference between the side face 22m and the stepped portion 22i is slightly greater than the total of the thickness of the leaf spring 31 and the thickness of the FPC 33. Moreover, at the side face 22m, at the end portion of the y-axial positive side, a stepped portion 22h is formed so as to be continuous from the groove 22g to the stepped portion 22i. The step difference between the side face 22m and the stepped portion 22h is slightly larger than the thickness of the FPC 33.

At the side face 22n on the x-axial negative side of the weight 22, at the end portion on the z-axial negative side, a stepped portion 22j is formed spanning from the first face 22a to the second face 22b. The step difference between the side face 22n the stepped portion 22j is slightly greater than the thickness of the leaf spring 32.

### <Coil 21>

The coil 21 is provided on the inside of the through hole 22c. Specifically, the coil 21 is provided in the storing space 23b in the through hole 22c, and has a ring shape. The coil 21 has a first face in the direction of the y-axial positive side, facing the second face of the driving magnet 42, and a second face in the direction of the y-axial negative side, facing the first face of the driving magnet 43. A gap, of a prescribed interval, is provided between the first face of the coil 21 and the second face of the driving magnet 42. A gap of a prescribed interval is provided between the first face of the driving magnet 43 and the second face of the coil 21. The coil 21 is formed through winding, in a prescribed winding direction, a single wire (hereinafter sometimes termed a “winding”) that has a first end and a second end.

### <Leaf Spring 31>

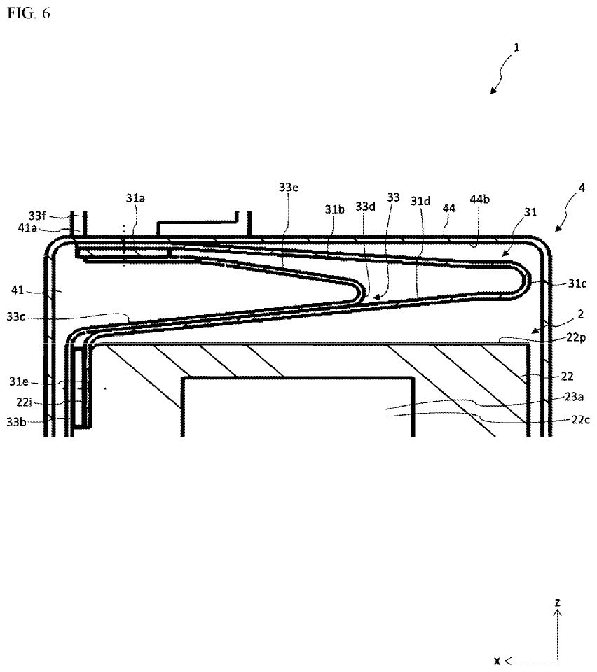

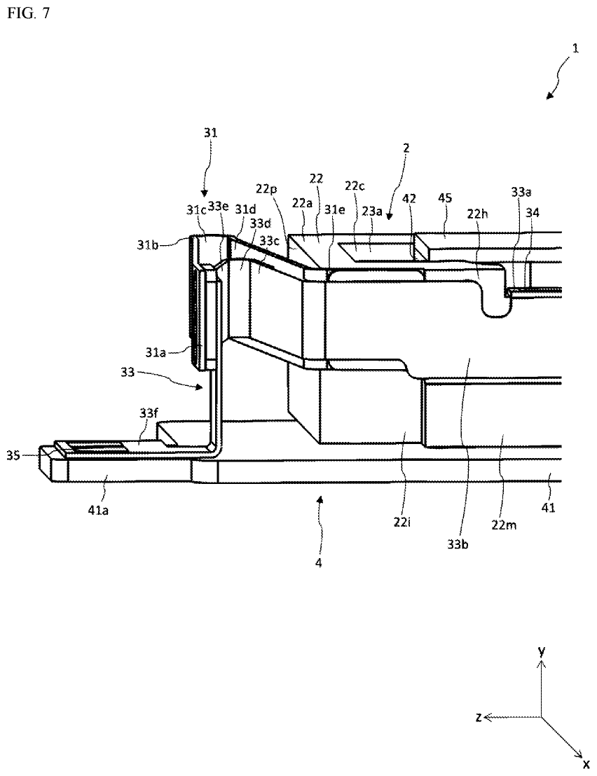

FIG. 6 is a cross-sectional drawing of a linear motor according to the present embodiment. FIG. 7 is a perspective diagram of a linear motor according to the present embodiment. FIG. 6 depicts a cross-sectional drawing along the section VI-VI in FIG. 5. FIG. 6 and FIG. 7 depict enlarged views of the z-axial positive side, in respect to the weight 22. Note that the case 44 is not shown in FIG. 7. Additionally, the connecting portion 5 is not shown in FIG. 7. As depicted in FIG. 1 through FIG. 7, the leaf springs 31 and 32 are provided between the case portion 4 and the movable portion 2. The leaf springs 31 and 32 are one specific example of “elastic members” in the present invention.

The leaf spring 31 is provided on the z-axial positive side in respect to the movable portion 2. Specifically, the leaf spring 31 is provided between the z-axial positive side inner peripheral surface 44b of the case 44 (referencing FIG. 4 and FIG. 5) and the weight 22. The leaf spring 31 is structured including a first end 31a, extending portions 31b and 31d, a U-shaped portion 31c, and a second end 31e. The leaf spring 31 has a shape wherein a single plate-shaped member is bent, where the first end 31a, the extending portion 31b, the U-shaped portion 31c, the extending portion 31d, and the second end 31e are continuous sequentially. The U-shaped portion 31c is one specific example of a “bend portion” in the present invention.

The first end 31a is secured to a case portion 4 that remains stationary in relation to the movable portion 2. The second end 31e is secured to the movable portion 2. In the U-shaped portion 31c, a plate-shaped member is shaped through bending back into a U shape. The extending portion 31b extends from the first end 31a toward the U-shaped portion 31c. The extending portion 31d extends from the second end 31e toward the U-shaped portion 31c.

Specifically, the first end 31a is secured to the x-axial positive side of the inner peripheral surface 44b of the case 44. The extending portion 31b is connected to the first end 31a, and is extended so as to be near to the side face 22p, while facing toward the x-axial negative side. The U-shaped portion 31c is connected to the extending portion 31b at the end portion on the z-axial positive side, to convert the direction of extension of the plate-shaped member of the leaf spring 31 to the x-axial positive side, while nearing the side face 22p. The extending portion 31d is connected to the end portion of the U-shaped portion 31c on the z-axial negative side, and extends so as to approach the side face 22p while directed toward the x-axial positive side. The second end 31e is connected to the extended portion 31d through the dotted lines that are parallel to the y axis, at the connecting part of the side face 22p and the stepped portion 22i in the weight 22, and secured to the stepped portion 22i of the weight 22.

In this way, the second end 31e is secured to the stepped portion 22i, enabling the leaf spring 31 to increase the mass of the weight 22 while preventing it from extending beyond the side face 22m of the weight 22. The leaf spring 31 provides a force of restitution to the weight 22 that is moving, through deformation of the shape based on the movement of the weight 22, along the movement direction.

### <Leaf Spring 32>

The leaf spring 32 is provided on the z-axial negative side in respect to the movable portion 2. Specifically, the leaf spring 32 is provided between the z-axial negative side inner peripheral surface 44c of the case 44 (referencing FIG. 4 and FIG. 5) and the weight 22. The leaf spring 32 is structured including a first end 32a, extending portions 32b and 32d, a U-shaped portion 32c, and a second end 32e. The leaf spring 32 has a shape wherein a single plate-shaped member is bent, where the first end 32a, the extending portion 32b, the U-shaped portion 32c, the extending portion 32d, and the second end 32e are continuous sequentially.

Specifically, the first end 32a is secured to the x-axial negative side of the inner peripheral surface 44c of the case 44. The extending portion 32b is connected to the first end 32a, and is extended so as to be near to the side face 22o, while facing toward the x-axial positive side. The U-shaped portion 32c is connected to the extending portion 32b at the end portion on the z-axial negative side, to convert the direction of extension of the plate-shaped member of the leaf spring 32 to the x-axial negative side, while nearing the side face 22o. The extending portion 32d is connected to the end portion of the U-shaped portion 32c on the z-axial positive side, and extends so as to approach the side face 22o while directed toward the x-axial negative side. The second end 32e is connected to the extended portion 32d through the dotted lines that are parallel to the y axis, at the connecting part of the side face 22o and the stepped portion 22j in the weight 22, and secured to the stepped portion 22j of the weight 22.

In this way, the second end 32e is secured to the stepped portion 22j, enabling the leaf spring 32 to increase the mass of the weight 22 while preventing it from extending beyond the side face 22n of the weight 22. The leaf spring 32 provides a force of restitution to the weight 22 that is moving, through deformation of the shape based on the movement of the weight 22, along the movement direction.

### <FPC 33>

The FPC 33 is a substrate that has flexibility, and includes the lead wires 34 and 35 for supplying electric power to the coil 21. The FPC 33 is structured including terminal portions 33a and 33f, extending portions 33b, 33c, and 33e, and also bend portion 33d. The FPC 33 is structured including the terminal portion 33a, the extending portion 33b, the extending portion 33c, the bend portion 33d, and the extending portion 33e, sequentially continuously.

The lead wires 34 and 35 are straight members that are formed from metal with high electrical conductivity, and are routed on the FPC 33 during coating. In the present embodiment, the lead wire 34 has a first end that is exposed at a terminal portion 33a, and a second end that is exposed at a terminal portion 33f, and is a copper film that is formed through patterning on the FPC 33. The lead wire 35 has a first end that is exposed at a terminal portion 33a, and a second end that is exposed at a terminal portion 33f, and is a copper film that is formed through patterning on the FPC 33.

The FPC 33 is provided bent next to the leaf spring 31. In the present embodiment, the FPC 33 is provided so that the direction of bending of the FPC 33 conforms to the direction of bending of the leaf spring 31, in the interior of the leaf spring 31. Moreover, the FPC 33 is provided so as to bend in the interior of the leaf spring 31.

Specifically, the terminal portion 33a has a surface that is parallel to the zx plane, and is provided on the bottom face of the groove 22g of the weight 22. The extending portion 33b has a surface that is parallel to the yz plane, and is provided so as to contact the second end 31e of the leaf spring 31 and the stepped portion 22h. The extending portion 33b is connected with the terminal portion 33a through the dotted lines that are parallel to the z axis, in the connecting part between the groove 22g of the weight 22 and the stepped portion 22h, and extends in the direction of the z-axial positive side.

The extending portion 33c is provided so as to run along the extending portion 31d of the leaf spring 31. In the present embodiment, the extending portion 33c is connected to the extending portion 33b through the dotted lines that are parallel to the y axis, to extend while in contact with the z-axial positive side face of the extending portion 31d of the leaf spring 31. Specifically, the extending portion 33c is connected to the extending portion 33b through the dotted lines, and extends so as to be directed toward the x-axial negative side, and to be away from the side face 22p.

The bend portion 33d is positioned between the extending portion 31b and the extending portion 31d of the leaf spring 31. The bend portion 33d is connected to the extending portion 33c that the z-axial negative side end portion, to convert the direction of extension of the FPC 33 to be toward the x-axial positive side, while being away from the side face 22p.

The extending portion 33e is connected to the end portion of the bend portion 33d on the z-axial positive side, and extends so as to be away from the side face 22p, directed toward the x-axial positive side. The terminal portion 33f has a surface that is parallel to the zx plane, and is connected to the extending portion 33e through the dotted lines that are parallel to the x axis, and is provided on the protruding plate 41a of the base plate 41.

### <Connecting Portion 5>

The connecting portion 5 is positioned in the groove 22g, and connects the lead wires 34 and 35 to the coil 21. In the present embodiment, the connecting portion 5 not only connects the first end of the winding of the coil 21 and the first end of the lead wire 34, but also connects the second end of the winding of the coil 21 and the first end of the lead wire 35. Specifically, the connecting portion 5 is provided in the introduction space 23d that is formed between the groove 22g and the bottom face 44a of the case 44. In the introduction space 23d, at the terminal portion 33a the first end of the winding of the coil 21 and the first end of the lead wire 34 are connected electrically through solder (not shown), and the second end of the winding of the coil 21 is connected electrically to the first end of the lead wire 35 through solder 5a (referencing FIG. 3). In this way, the connecting portion 5 is provided in the introduction space 23d, where the solder buildup is contained within the introduction space 23d, making possible to reduce the possibility of contact between the solder and the case 44. Note that in the connecting portion 5, the first end of the winding of the coil 21 may be connected to the first end of the lead wire 35 with the second end of the winding of the coil 21 connected to the first end of the lead wire 34.

### <Mobile Information Terminal 100>

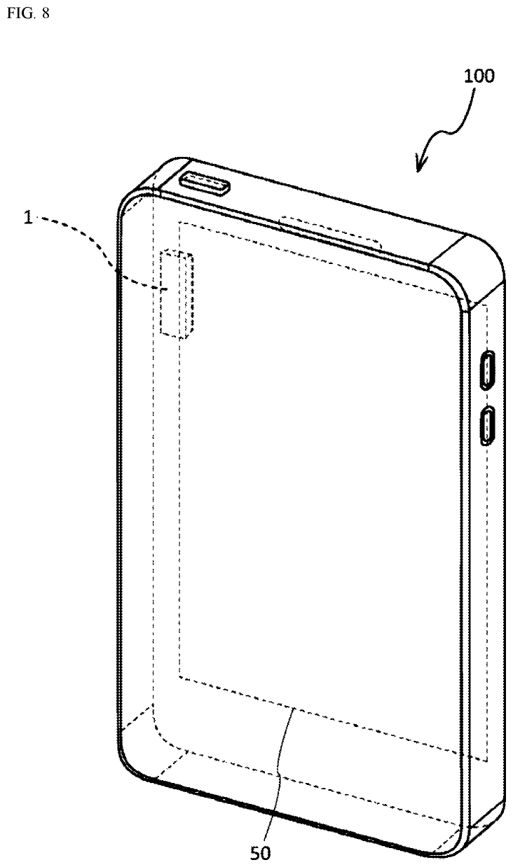

FIG. 8 is a perspective diagram of a mobile information terminal according to the present embodiment. The mobile information terminal 100 is structured including a linear motor 1 and a touch operating panel 50. The mobile information terminal 100 is a consumer electronics product comprising the touch operating panel 50. Specifically, the mobile information terminal 100 is, for example, a smart phone. Note that the mobile information terminal 100 may instead be a tablet, a laptop computer, a game controller, or the like. The mobile information terminal 100 is one specific example of an “electronic device” in the present invention.

The touch operating panel 50 is, for example, a touch display. The mobile information terminal 100 is structured to cause the linear motor 1 to vibrate in response to a touch operation on the touch operating panel 50. The linear motor 1 has a large mass on the movable portion 2, and thus has good vibrational characteristics. Through this, good responsiveness can be achieved, even when repetitively starting and stopping vibration of the mobile information terminal 100, corresponding to repetitive brief touch operations. The touch operating panel 50 may have a configuration that is a touchpad. Moreover, the configuration may be one wherein the linear motor 1 is provided in an electronic device that does not have a touch operating panel 50.

Given the linear motor structured as described above, the groove 22g is formed in the first face 22a, thus making it possible to secure the introduction space 23d for connecting the outside of the movable portion 2 and the through hole 22c, between the case 44 and the weight of 22, while still securing a larger mass for the weight 22. Through this, it is possible to supply the electric current from outside of the movable portion 2 through the introduction space 23d to the coil 21 that is positioned on the inside of the through hole 22c. That is, in the linear motor 1 that is provided with the coil 21 on the movable portion 2, it is possible to supply electric current to the coil 21 while still increasing the mass of the movable portion 2.

With the linear motor of the configuration set forth above, the connecting portion 5 between the winding of the coil 21 and the lead wires 34 and 35 that supply electric power to the coil 21 is positioned in the groove 22g, thus making it possible to approach the connecting portion 5 from the side of the first face 22a that is more open, enabling the operations for connecting the winding of the coil 21 to the lead wires 34 and 35 to be carried out more easily. This enables an improvement in manufacturability of the linear motor 1.

With the linear motor of the configuration set forth above, the direction of the groove 22g crosses the direction of movement of the movable portion 2, thus enabling, for example, introduction of the lead wires 34 and 35 for supplying the electric current to the coil 21 from the direction of the side of the movable portion 2, making possible to secure space on the side in the direction of motion of the movable portion 2. This enables greater freedom in the design of the linear motor 1.

The linear motor of the configuration set forth above enables an increase in the magnetic flux density in the coil 21 through the driving magnets 42 and 43 facing each other with the coil 21 therebetween, thus enabling an increase in the electromagnetic force that is applied to the coil 21. This enables an increase in the driving force in respect to the movable portion 2, thus enabling an increase in the strength of the vibration of the linear motor 1.

The linear motor of the configuration set forth above enables the provision of the lead wires 34 and 35, for supplying electric power to the coil, on a substrate that has flexibility, such as, for example, routing the lead wires 34 and 35 on the substrate of an FPC 33, enabling routing of the lead wires 34 and 35 while preventing entanglement.

An example according to the present invention was explained in detail above. The explanation above is no more than an explanation of one form of embodiment, and the scope of the present invention is not limited to this form of embodiment, but rather is interpreted broadly, in a scope that can be understood by one skilled in the art.

While, in the actuator according the present embodiment, the explanation was for a configuration wherein two driving magnets were secured in the case portion 4, the configuration may instead be one wherein a single driving magnet is secured in the case portion 4.

While the explanation for the actuator according to the present embodiment was for a configuration wherein the weight 22 was provided in the through hole 22c, the configuration may instead be one wherein a recessed portion that does not pass through the weight 22 is provided as the opening portion. The recessed portion may, for example, be provided in the first face 22a of the weight 22, or may be provided in the second face 22b of the weight 22, or may be provided in both the first face 22a and the second face 22b. For example, when the recessed portion is provided in the first face 22a or the second face 22b, a single driving magnet would be secured onto the surface of the case 44 that faces the recessed portion.

Moreover, while, in the actuator according the present embodiment, the explanation was for a configuration wherein leaf springs 31 and 32 were one specific example of “elastic members,” the configuration may instead be one wherein other types of springs, such as coil springs, spiral springs, or the like, is the specific example of the “elastic members.”

Moreover, while, in the actuator according the present embodiment, the explanation was for a configuration wherein the through hole 22c was provided in the first face 22a of the weight 22, the configuration instead may be one wherein a hole that does not pass all the way through, that is, a recessed portion, is provided in the first face 22a of the weight 22. In this case, the coil 21 would be provided on the inside of this recessed portion.

While, in the actuator according to the present embodiment, the explanation was for a configuration wherein the connecting portion 5 was provided in the groove 22g, the configuration may instead be one wherein the connecting portion 5 is provided at a position other than that of the groove 22g, for example, on the inside of the through hole 22c or on the outer surface of the weight 22. Specifically, when the connecting portion 5 is provided on a wall face of the through hole 22c, for example, the depth of the groove 22g can be made shallower, making it possible to increase the mass of the weight 22. However, because the through hole 22c is less open when compared to the groove 22g, preferably the configuration is one wherein the connecting portion 5 is provided in the groove 22g, which has good accessibility.

Moreover, while in the actuator according the present embodiment, the explanation was for a case wherein the direction of the groove 22g was the x axial direction, which was perpendicular to the z axial direction that is the direction of movement of the movable portion 2, instead the configuration may be one wherein the direction of the groove 22g crosses the direction of movement of the movable portion 2, without being perpendicular.

Moreover, while in the actuator according to the present embodiment the explanation was for a configuration wherein the lead wires 34 and 35 routed on the FPC 33 during coating, the configuration may instead be one wherein coated lead wires 34 and 35 are routed as-is.

While in the actuator according to the present embodiment the explanation was for a configuration wherein the entirety of the lead wires 34 and 35 were connected on the FPC 33, the configuration may instead be one wherein a portion of the lead wires 34 and 35 are routed on the FPC 33.

The present invention can be used suitably as an actuator for causing vibrations in an electronic device such as a smart phone, a tablet, a laptop computer, a game controller, or the like.

1. An actuator comprising:
a case portion comprising a permanent magnet;
a movable portion that can move in respect to the case portion; and
elastic members provided between the case portion and the movable portion, wherein:
the movable portion comprises:
a weight portion that has a flat portion that faces the case portion, and an opening portion in the flat portion; and
a coil that is provided inside of the opening portion, wherein:
a groove connecting the opening portion and the outer surface of the weight portion is provided in the flat portion.

2. The actuator as set forth in claim 1, comprising:
a lead wire supplying electric power to the coil; and
a connecting portion connecting the lead wires and the coil,
wherein the connecting portion is positioned in the groove.

3. The actuator as set forth in claim 1, wherein:
the direction of the groove crosses the direction of movement of the movable portion.

4. The actuator as set forth in claim 1 wherein:
the case portion includes two permanent magnets that face each other with the coil therebetween.

5. The actuator as set forth in claim 1, further comprising:
a lead wire supplying electric power to the coil; and
a substrate that has flexibility, and on which at least a portion of the lead wire is provided.

6. An electronic device, comprising an actuator as set forth in claim 1.
